(19) United States
(12) Patent Application Publication
(10) Pub. No.: US 2026/0337387 A1
(43) Pub. Date: Oct. 29, 2026

(54) EXTRUSION & ARTICLES OF MANUFACTURE

(71) Applicant: PETER F. CLOEREN, ORANGE, TX (US)

(72) Inventor: PETER F. CLOEREN, ORANGE, TX (US)

(73) Assignee: CLOEREN INCORPORATED, Orange, TX (US)

(21) Appl. No.: 18/823,343

(22) Filed: Sep. 3, 2024

Related U.S. Application Data
(63) Continuation-in-part of application No. 18/814,053, filed on Aug. 23, 2024.

(51) Int. Cl. C08L 23/06; B29C 48/00; B29C 48/08; B29C 48/09; B29C 48/21; B29K 23/00; B29K 105/00; B32B 1/08; B32B 27/08; B32B 27/32

(52) U.S. Cl. CPC C08L 23/06; B29C 48/022; B29C 48/08; B29C 48/09; B29C 48/21; B32B 1/08; B32B 27/08; B32B 27/32; B32B 27/327; B29K 2023/06; B29K 2023/0625; B29K 2105/0094; B29K 2995/0073; B29K 2995/0082; B29K 2995/0096; B32B 2250/242; B32B 2307/406; B32B 2307/414; B32B 2307/546; B32B 2307/734; B32B 2307/746; C08L 2203/16; C08L 2203/30; C08L 2205/025; C08L 2314/06

(57) ABSTRACT

The present invention is directed to an improved extrusion process for converting polymers into plastic articles, and to the plastic articles made thereby, including extruded polymeric compositions useful for converting into plastic articles. Beneficially, use of fluoropolymers, in particular per- and polyfluoroalkyl substances (PFAS), as polymer processing aids, to avoid slip-stick defects, is avoided. In place thereof, a low viscosity thermoplastic admix immiscible with a higher viscosity thermoplastic polymer, reduces the shear stress acting on a viscous flow stream comprising the polymer, by migrating to a flow stream surface.

### FIELD OF THE INVENTION

This invention relates to improved processability of viscous polymeric extrudates subject to slip-stick effects.

### BACKGROUND OF THE INVENTION

Converting thermoplastic polymers into plastic articles is accomplished by feeding such polymers to an extruder whereby the polymer is heated by shear to a temperature above its melting point and is extruded therefrom as a viscous fluid through a flow channel, including an extrusion die, whereby the extrudate is formed to a shape suitable for converting into a desired plastic article, such as for example a plastic pellet useful for re-extrusion, packaging film, pipe, parison, bottle, protective sheath over a wire and cable, etc. As can be readily understood, it is desirable to extrude at as high a speed as possible for economic reasons. Although the extrusion rate may be increased, there is a limit or threshold above which steady-state flow of the viscous flow stream may be disrupted or disturbed, and so-called “slip-stick” effects may be observed with certain high viscosity polymers.

Slip-stick effects and melt flow disturbances are commonly termed, by way of example, as melt fracture, sharkskin, waves, parabola(s), chevrons, zig-zags, turbulence (although there is no turbulence possible under laminar flow), interfacial instabilities, surface defects, and so forth. See, for example, pages 24-26 of J. Dooley, “Viscoelastic Flow Effects in Multilayer Polymer Coextrusion”, Technische Universiteit Eindhoven, 2002. Slip-stick effects caused by exceeding the allowable peak shear stress of a polymeric flow stream at a flow channel boundary can effect intra-, and/or in the case of coextrusion, inter-laminar flow stream melt disturbances, including slip-stick melt disturbances. The terms “slip-stick” and “stick-slip” are synonymous and may be used interchangeably.

More specifically, “slip-stick” effects can occur when a viscous flow streamline is caused to slip over an adjacent fluid parcel or another boundary by excessive shear forces acting upon the subject flow streamline. This slip corresponds to an abrupt or sudden change of the fluid flow velocity along a streamline. When the excess shear stress acting on a streamline is relieved by slip, normal non-slip (stick) flow along the streamline path is reestablished—as fast as it was disrupted. These sudden or abrupt changes in flow streamline velocities correspond to unwanted disturbance of the flow stream. The unwanted disturbance can present itself as a change in surface roughness (melt fracture), or larger thickness changes of the affected extrudate. The slip-stick cycle repeats itself until a solution is effected, i.e., a permanent reduction of the shear stress acting upon a flow streamline. The periodic cycle of slip-and-stick can be at relatively high frequencies (cycles per second).

To define more clearly the terms used herein, the following definitions are provided. Unless otherwise indicated, the following definitions are applicable to this disclosure.

By the term “admixed” or “admixing” is meant, the dosing of a polymer with an admix by “extrusion”.

By “extrusion” is meant, extruding a molten polymer under heat and pressure through an extrusion die. The die may be any shape, including an elongated nozzle, or an annular nozzle, suitable for forming a plastic article therefrom.

By “high viscosity polymer” is meant, a thermoplastic subject to slip-stick affects and is typically identifiable by a zero-shear viscosity of at least 1,000 Pa·s at 230 °C.

By the term “homopolymer” is meant, a polymer free of comonomers.

By the term “host polymer” is meant, a thermoplastic polymer subject to dosing with a polymer processing aid (“PPA”). The host polymer may include one polymer, or a homogenous blend of multiple miscible polymers, and may further include additional minor constituents.

By the term “hydrocarbon” is meant, a compound containing only carbon and hydrogen.

By the term “layer” is meant, a polymeric mass extruded into a shape having two generally opposing faces or interfaces, or one face and one interface. By the term “face” is meant an exterior surface of the polymeric extrudate. By the term “interface” is meant a common boundary between two immediately adjacent polymeric masses. For further purposes of this description, two adjacent layers sharing a common boundary and having the same composition, shall each be deemed to be a “layer” when fed from two separate extruders.

MFI (melt flow index) and MFR (melt flow rate) are measurements of a polymer's mass flow rate in g/10 minutes, in accordance with ASTM D1238. For purposes of this description, MFI is a measurement made at 190 °C, and MFR is a measurement made at 230 °C.

By the term “Newtonian viscosity” is meant, a fluid whose viscosity is independent of shear rate, i.e., where the viscosity does not change with changes of shear rate within an identified or determined shear rate range. Many pseudoplastic polymers, including polyethylenes, exhibit Newtonian viscosity characteristics at lower shear rates and non-Newtonian viscosity characteristics at higher shear rates (for illustration, see FIG. 8).

The term “polyethylene” or “polyethylenes”, as used herein, includes ethylene homopolymers, copolymers, terpolymers, and the like, as well as alloys and blends thereof. A copolymer is derived from polymerization of an olefin monomer and one type of olefin comonomer, while a terpolymer is derived from polymerization of an olefin monomer and two types of olefin comonomers. Accordingly, “polyethylene” or “polyethylenes” encompasses homopolymers, copolymers, and terpolymers derived from any olefin monomer and comonomer(s) disclosed herein, including C3 to C8 olefins, including elastomers and plastomers thereof. Similarly, the scope of the term “polymerization” includes homopolymerization, copolymerization, and terpolymerization.

By the term “polymer” is meant, a substance consisting of molecules characterized by the repetition (neglecting ends, branch junctions and other minor irregularities) of one or more types of monomeric units (ASTM D883-23). Further, the term “polymer” also includes all possible geometrical configurations, unless stated otherwise, and such configurations may include atactic, isotactic, syndiotactic, and random geometries.

By the term “pseudoplastic” is meant, a fluid whose viscosity is subject to decrease with increasing shear rate or shear stress.

By “shear stress” is meant, the force acting upon a fluid, and is calculated by multiplying the shear rate times the fluid viscosity. By “peak shear stress” is meant for purposes of this description, the shear stress generated at a flow channel boundary. By “critical shear stress” is meant for purposes of this description, the force at which a fluid streamline is caused to slip-and-stick over itself or along a boundary, for example, a flow channel wall.

By the term “thermoplastic” is meant, a polymer that repeatedly can be softened by heating and hardened by cooling through a temperature range characteristic of the polymer, and that in the softened state can be shaped into polymeric articles.

By the term “viscosity” is meant, the measurement of the resistance to flow due to internal friction. Also, more simply defined as, the measurement of resistance of a fluid to flow.

By the term “zero-shear viscosity” is meant, the viscosity of a fluid at rest, i.e., no shear acting upon the fluid. The zero-shear viscosity of a pseudoplastic fluid may be identified, or determined, when the fluid exhibits a Newtonian viscosity characteristic at low shear rates, i.e., shear rates ≤10.0 sec.⁻¹. This Newtonian region is also known as the Newtonian Plateau of a pseudoplastic fluid. Some pseudoplastic polymers, including some polyethylene polymers, do not exhibit a Newtonian Plateau at shear rates ≥0.1 sec.⁻¹, and in such cases, its zero-shear viscosity may be stated as being greater than or equal to its identifiable viscosity at a shear rate of ≥0.1 sec.⁻¹ and ≤10 sec.⁻¹ (for illustration, see FIG. 7).

The viscosity of most thermoplastics is temperature dependent, as illustrated in FIG. 8. That is, as the extrusion process temperature is increased, viscosity decreases, and as the extrusion process temperature is decreased, viscosity increases. Accordingly, when a specific viscosity value is described, a reference temperature must be stated to validate the referenced viscosity value. Depending on the type of extrusion process, the process temperature of the polymers can range from about 200 °C to about 330 °C. For blown film and blow molding processes, lower temperatures within this range are beneficial to the process, and for extrusion coating, higher temperatures within this range are commonly favorable to the process. Accordingly, it is beneficial that a processing aid be thermally stable across the entire process temperature range, independent of the selected extrusion process or host polymer.

Flow channel pressure can be determined by multiplying the shear stress at the flow channel boundary times the wetted perimeter of the flow channel. Accordingly, an increase in the flow channel boundary shear stress would correlate to an increase in operating pressure; and conversely, a decrease in boundary shear stress would correlate to a decrease in operating pressure.

Compared to extrusion of a monolayer, avoiding melt flow disturbances in coextrusion becomes an even more incredibly complex science. See for example, the melt flow disturbance illustrated by FIG. 1 in U.S. Pat. No. 4,533,308 to Peter Cloeren, and the following Ramanathan, Dooley and Schrenk coextrusion prior art that relates to overcoming slip-stick disturbances and effects.

As described by U.S. Pat. No. 5,269,995 to Ramanathan, and further discussed at page 19 of Dooley, in the coextrusion of very thin layers, instability in the layers or layer interfaces near the peak stress region of the flow channel walls, can lead to melt flow disturbances, including stick-slip disturbances. As further described by Ramanathan and Dooley, protective boundary layers added to a molten flow stream during coextrusion may be used to move very thin layers away from the high stress region of the flow channel walls. Schrenk et al, “Interfacial Flow Instability in Multilayer Coextrusion,” Polymer Engineering And Science, June 1978, Vol. 18, No. 8, pp 620-623, describes decreasing the viscosity of the layer nearest the flow channel wall by increasing the extrusion temperature or changing to a lower viscosity resin, or reducing the extrusion rate, or increasing the die gap, to abate melt disturbances. A drawback with increasing the extrusion temperature is that many thermoplastic polymers are typically extruded at temperatures causing time dependent decomposition of the extruded polymer(s).

As illustrated by U.S. Pat. No. 3,125,547 to Blatz and U.S. Pat. No. 7,449,520 to Chapman, Jr. et al., for decades, the use of fluoropolymers, in particular per- and polyfluoroalkyl substances (PFAS), as polymer processing aids has been the method of choice to mitigate slip-stick defects in the extrusion of a host polymer subject to slip-stick affects, in particular polyethylenes. Although fluoropolymers have been used in different ways, admixing of PFAS, which are typically highly viscous polar polymers, with a host polymer has been common.

It is broadly accepted that the effectiveness of admixed PFAS, as a processing aid, is due to their immiscible relationship with the host polymer and affinity to metal, whereby during extrusion the PFAS migrates to, and bonds to, the metallic walls forming the flow channel of an extrusion head so as to form, on a molecular scale, a polymeric boundary layer on the metallic flow channel wall(s) by polar attraction. Thus, consistent with this mechanism, a viscous host polymer is isolated from metallic contact by the fluoropolymer boundary layer, and is thereby in direct fluid communication with the much lower surface energy fluoropolymer boundary layer, instead of with the higher surface energy metallic wall of the flow channel. The lower surface energy of the fluoropolymer boundary layer provides a higher wetting angle for the viscous host polymer, and reduces the shear stress below the critical shear stress at which the viscous host polymer would otherwise be subject to unwanted slip-stick affects associated with the higher surface energy metallic wall.

As illustrated by Nova Chemical PFAS-containing, linear low density polyethylene FP120C, or ExxonMobil PFAS-containing, linear low density polyethylene 1012MA, PFAS may be commonly admixed at minimal levels into polymeric pellets supplied to the extrusion converter, or may be admixed, or further admixed at the extruder, by an extrusion converter, or both, as is commonly practiced. In the case of the later, the dosing level can increased to be between about 0.5% and 3% wt. per selected admixed melt layer.

With legislative and voluntary bans of PFAS in the United States, and anticipated multi-national bans, the plastic extrusion industry has been thrust into finding a suitable replacement polymer processing aid to abate deleterious melt disturbances, including slip-stick affects, in polymers subject to same, in particularly for alpha-olefin copolymer polyethylenes, including ethylene 1-butene, ethylene 1-hexene, and ethylene 1-octene comonomers, which are commonly known as linear polyethylenes (“LPEs” or in the singular “LPE”), including metallocene catalyzed linear polyethylenes (“mLPEs” or in the singular “mLPE”). Although other polymer processing aids such as used in linear low density polyethylenes such as FP120-C02, and 1012RA have been introduced to the commercial marketplace, limited benefit in mitigating slip-stick affects has been observed.

Accordingly, there remains a need for an improved extrusion processing aid that can replace PFAS and yet substantially maintain the performance properties of the extrudate and of the articles of manufacture thereby produced, and furthermore there remains a need for PFAS-free articles of manufacture.

Therefore, objectives of this invention are to provide extruded thermoplastic articles free of melt disturbances and yet substantially maintain the performance properties of the extrudate, and to provide an improved process for the extrusion of a low melt flow (high viscosity) host polymer subject to melt disturbances.

More specifically, there is a need for the performance properties of the extrudate to be minimally affected. For some commercial uses, more latitude in performance properties is permitted, whereas for other commercial uses, less latitude is permitted. Further objectives are to prevent degradation of the host polymer and contamination thereby of the molten polymeric matrix and in the extrudate with black carbon particulates, as well as to prevent build-up of unwanted degraded polymeric deposits on the extrusion equipment, in particular on the die lips.

Additional advantages and beneficial features of the present invention are set forth in the drawing and detailed description, and in part will become apparent to those skilled in the art upon examination of the drawing and detailed description, or may be learned by practice of the invention. As will be realized, this invention is capable of modifications in various respects, all without departing from the invention. Accordingly, the drawing and the detailed description are to be regarded as illustrative in nature, and not as restrictive.

### BRIEF DESCRIPTION OF THE DRAWING

Reference is now made to the accompanying drawing which forms a part of the specification of the present invention, and which illustrates embodiments of articles of manufacture in accordance with the present invention.

FIGS. 1 to 4 are perspective views, each showing a portion of a generally planar article manufacture useful as a film, and FIGS. 5 and 6 are cross-sectional views, each showing a portion of an annular article of manufacture useful as a pipe, parison, wire and cable jacket, etc.;

FIG. 7 illustrates negligible differences in the viscosity of a polymer subject to slip-stick affects, without and with PFAS admix, at 230 °C;

FIG. 8 illustrates the viscosity of a host polymer subject to slip-stick affects, and of an inventive admix, at 210 °C, 230 °C, and 250 °C; with change in shear rate.

FIG. 9 includes photographs that illustrate the invention and were taken of various extrudates from a capillary rheometer experiment at multiple shear rates in the range of 100 to 1000 sec⁻¹, to evaluate susceptibility of a polymer to slip-stick affects, with and without the inventive admix.

### SUMMARY OF THE INVENTION

In one aspect, the present invention provides extruded plastic articles free of slip-stick defects, and that are beneficially PFAS-free. The extruded article may be generally described as a polymeric article that includes one or more outer surfaces or faces, and typically includes opposing outer surfaces, and may have one or more layers.

By the term “host matrix” is meant for purposes of this description, a matrix that includes at least a host polymer, as a major constituent, admixed with an immiscible polymer as a minor constituent that has a viscosity lower than the host polymer. A host matrix or host polymer may include inorganic and/or organic components, for example calcium carbonate, titanium dioxide, silicas, silicates, and anhydrites, useful for anti-blocking (“AB”), and amides, including erucamide, and oleamide, useful as slip agents, as one or more additional minor constituents, in an amount as may be beneficial to the processability or properties of the extrudate. In any event, the host matrix is beneficially composed of at least 50% wt. thermoplastic.

The amount of an inventive admix (hereinafter defined) in a host matrix, although selected to be sufficient to abate slip-stick otherwise affecting the host polymer during extrusion, is beneficially insufficient to materially affect important performance properties of the plastic article. Accordingly, an inventive polymeric article is free of slip-stick defects and yet the performance properties are substantially maintained as if the inventive admix were not present.

An inventive admix is beneficially a polyolefin homopolymer obtained by the polymerization of monoolefins having the general structure CH₂═CHR, where R is an alkyl radical and the alkyl radical contains not more than one carbon atom. An inventive admix beneficially has a zero-shear viscosity less than, or equal to, 25 pascal seconds (“Pa·s”), and even more beneficially less than 10 Pa·s, at 230 degrees C. The relatively lower viscosity, inventive admix is beneficially immiscible with a host polymer.

In a variation, the present invention provides an extruded polymeric composition that includes at least a host polymer and inventive host matrix, and that is beneficially PFAS-free and useful for converting into a PFAS-free plastic article free of slip-stick defects. Illustrative is a thermoplastic pellet.

In accordance with a second aspect of the present invention, an inventive process for making an extruded plastic article free of slip-stick defects, is provided. In accordance with the process, a viscous flow stream that includes a host matrix of at least the host polymer and an inventive admix is extruded. The host polymer is subject to slip-stick affects, and is further characterized by a higher viscosity than the inventive admix. During extrusion, under time and shear, the lower viscosity and immiscibility of the inventive admix allows for viscous migration thereof to the high stress regions of a host matrix flow stream under the principles of fluid dynamics. As a result, shear stress acting on the flow stream is reduced below the critical threshold of the host polymer and unwanted slip-stick affects are abated.

Thereafter, the extrudate is converted from a molten fluid phase extrudate to a solid phase polymeric article free of deleterious degradation and slip-stick defects. Beneficially, the requisite performance properties of the extruded plastic article are substantially maintained as if the inventive admix were not present.

In the case of a coextruded multilayer extrudate, the viscous flow stream may include at least one additional molten host matrix, which may be immediately adjacent to, or spaced apart from, the previously described, molten host matrix. If spaced apart from one another by one or more additional layers, the compositions of the host matrices may be the same or different.

### DETAILED DESCRIPTION OF THE INVENTION

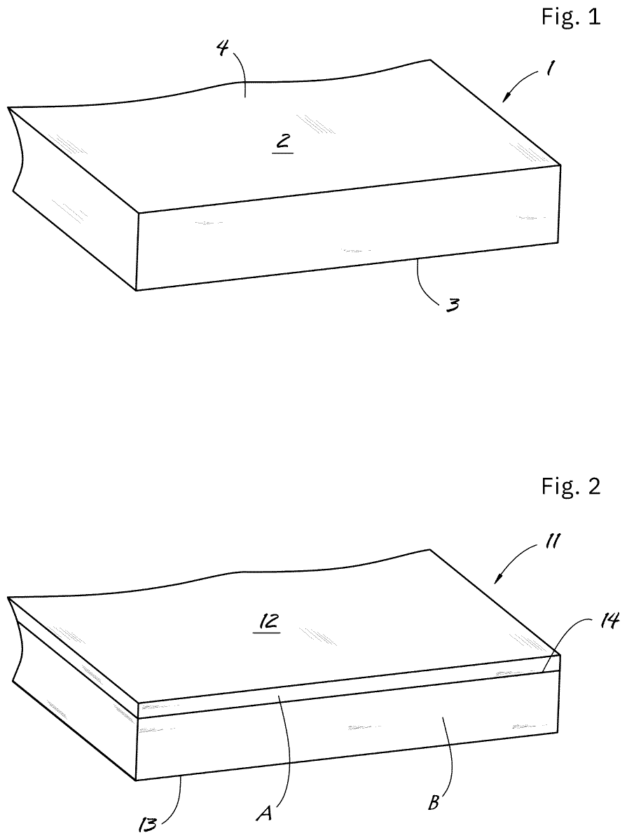

In accordance with the invention, extruded polymeric articles free of slip-stick defects are beneficially obtained, advantageously free of PFAS. With reference in particular to FIG. 1, an extruded article 1 may be generally described as a host matrix 4 in accordance with the present invention, that includes a host polymer and an inventive admix, which are beneficially co-recyclable. A host polymer in accordance with the present invention, and subject to unwanted slip-stick affects, may, for example, be a polyethylene, regardless of the catalyst used to produce the polymer, including blends with other miscible polymers. A host matrix may include from about 0.3% to 10% wt. of an inventive admix, beneficially from about 0.3% to 5% wt., and preferably from about 0.3% to 3% wt.

With continued reference to FIG. 1, host matrix 4 includes opposing faces 2,3 that, as also illustrated by FIGS. 2-4, may be generally coplanar, or that, as illustrated by FIGS. 5-6, may be concentric, or otherwise generally opposing. The opposing faces are separated from one another by a mass having a thickness that may be in the range of about 1 μm to 30 mm. Illustrative articles are plastic film (illustrated by FIGS. 1-4) and plastic pipe or parison (illustrated by FIGS. 5-6).

The extruded articles may be monolayer (as illustrated by FIGS. 1 and 5) or consist of multiple layers (as illustrated by FIGS. 2-4 and 6). For multilayered articles, the composition of at least one of the multiple layers may be different from the composition of another one of the layers. Multilayered articles may include from 2 to more than 1000 layers.

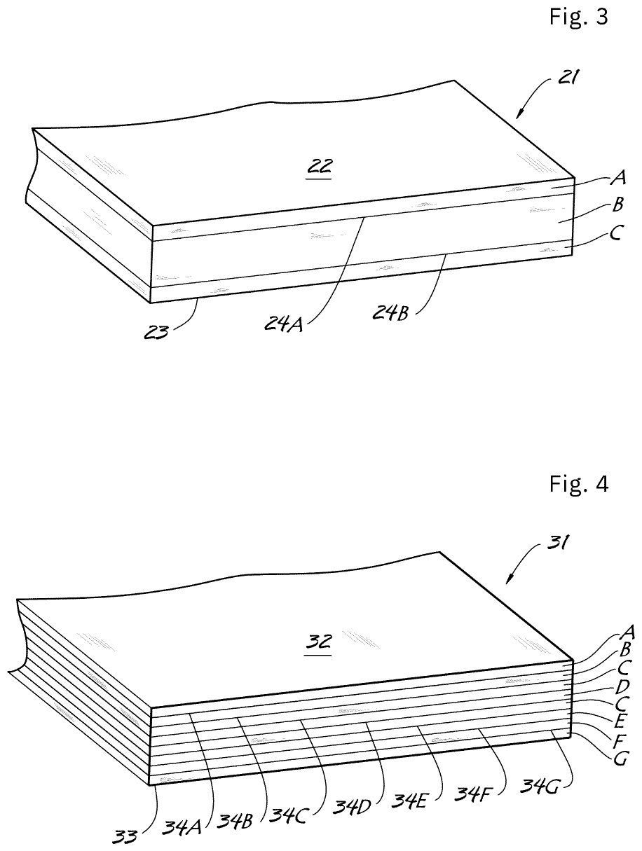

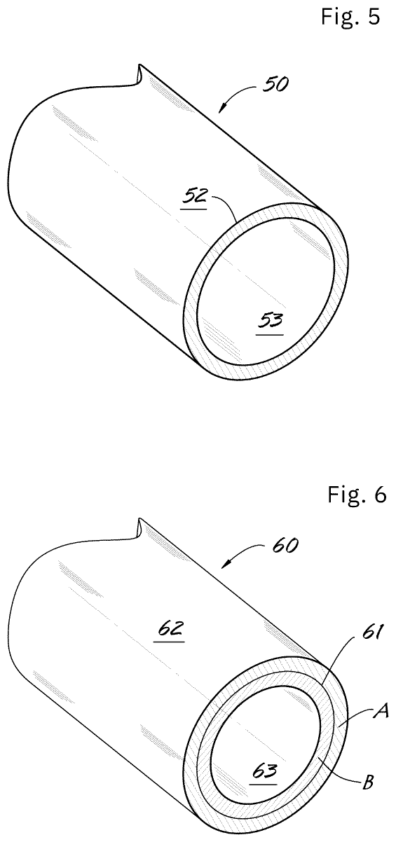

Further description of FIGS. 1 to 6 is now provided. With reference to FIG. 1, generally planar sheet 1 includes opposing major exterior faces 2 and 3. Referring to FIG. 2, a two-layer, generally planar sheet 11 comprising layers A, B, includes opposing major outer faces 12 and 13 and a layer interface 14. Referring to FIG. 3, a three-layer, generally planar film 21 comprising layers A, B, C, includes opposing major outer faces 22 and 23, and layer interfaces 24A, 24B. Referring to FIG. 4, a multilayer, generally planar film 31 comprising layers A, B, C, D, C, E, F, G, includes opposing major outer faces 32 and 33, and layer interfaces 34A, 34B, 34C, 34D, 34E, 34F, and 34G. Referring to FIG. 5, an annular article 50 includes opposing major outer surfaces 52 and 53, both being outer faces of the extrudate; and referring to FIG. 6, a two-layer, annular plastic article 60 includes opposing major outer faces 62 and 63 and a layer interface 61 delineating layers A and B. With reference to the foregoing illustrated extrudates, beneficially at least one outer layer includes an inventive host matrix. Layer designation, for purposes of this description, references the corresponding extruder. For example, layers C in FIG. 4 are extruded by extruder C.

In a specific embodiment, as illustrated by FIG. 3 and exemplified by experimental sample ET3 of Example 3, outer layer A of multilayer film 21 provides opposing outer face 22, and outer layer C provides opposing outer face 23, and outer layers A, C are separated by layer B. Although layers A, C comprise the same inventive host matrix, i.e., the same host polymer, the same inventive admix, and the same wt. percentage of both, A, C could be comprised of different inventive host matrices. Outer layer C may be comprised of, for example, a different host polymer, a different inventive admix, or different weight percent contributions, or combinations thereof. The percentage mass of each of the layers is described in Table 1.

In another specific embodiment, as illustrated by FIG. 4 and exemplified by Experimental Sample ET4 of Example 4, outer layer A of multilayer film 31 provides opposing outer face 32, and outer layer G provides opposing outer face 33. Outer layers A, G are separated by multiple layers as indicated by Table 4, and provided by extruders B, C, D, E, F. Although layers A, G comprise the same inventive host matrix, i.e., the same host polymer, the same inventive admix, the same antiblock additive, and the same wt. percentage of each, A, G could be comprised of different inventive host matrices. The percentage mass of each of the layers is described in Table 4.

An extruded polymeric composition in accordance with the present invention may be any shape or form useful for converting into an extruded plastic article free of slip-stick defects.

As now described, inventive polymeric articles are made in accordance with the subject inventive extrusion process. Beneficially, performance properties of the host polymer are substantially maintained.

In accordance with the inventive process, unwanted slip-stick affects may be abated for a viscous thermoplastic flow stream subject to slip-stick affects. Flow resistance is affected by fluid viscosity: the higher the fluid viscosity, the greater the resistance to flow; and conversely, the lower the fluid viscosity, the lower the resistance to flow. In fluid flow, the resistance to flow is greatest at a flow channel boundary. By the inventive approach, the shear stress acting upon a viscous laminar flow stream in fluid communication with a flow channel boundary, is reduced below the critical shear stress at which slip-stick would otherwise develop. As indicated, these viscous polymers include, in particular LPEs.

As described by Schrenk et al, in polymer melts of substantially different viscosities, the lower viscosity resin migrates to the region of highest shear stress. Thus, when extruding a low viscosity, immiscible fluid together with a high viscosity (low melt flow) host polymer, the lower viscosity immiscibles will migrate to the region of highest shear, i.e., at the flow channel boundaries, to minimize the energy dissipation of the flow stream under the principles of fluid dynamics. Under fluid flow extrusion conditions, a polymer immiscible with a host polymer and used as a PPA in accordance with the present invention, i.e., an inventive admix, beneficially forms a plurality of non-miscible domains in the high stress region of the host matrix boundary. Unlike PFAS processing aids, an inventive admix lacks affinity to the metal surfaces of the extrusion system. The inventive admix is also believed to beneficially affect the wetting angle, and surface renewal, of the host matrix at the flow channel boundaries.

Therefore, as described herein, the inventive approach is based upon a low viscosity immiscible polymer being separate domains within the continuity of a high viscosity host polymer. Under time and shear, a plurality of the low viscosity separate domains beneficially migrate to the high stress regions of a fluid flow field. As a result a boundary of the host matrix includes the host polymer and a plurality of domains of the immiscible polymer. In accordance with the invention, the effect of an inventive admix at the flow channel boundaries reduces the peak shear stress below the critical shear stress at which slip-stick effects would otherwise occur. In contrast, as a result of polar attraction to the metal flow channel boundaries, the immiscible PFAS separates from a host polymer and forms a PFAS boundary layer between the polymeric flow stream and the flow channel walls.

Furthermore, in accordance with the invention, it is desirable to minimize the inventive admix content required. In this respect, it is desired that contributions of the host polymer to the extruded article, for example, flex modulus, surface energy, tensile-yield characteristics, heat sealability, hot tack, surface haze, and so forth, are minimally affected. Accordingly, it is beneficial to dose a viscous host polymer with the least amount of the inventive admix sufficient to obtain an extrusion product free of slip-stick defects.

In accordance with the invention, as described herein, the inventive process advantageously effects a reduction of the shear stress otherwise acting upon a viscous host matrix sufficient to abate or prevent unwanted melt disturbance, without measurably or objectionably affecting the desired physical and/or mechanical properties of the extruded article obtained therefrom.

Extruding miscible polymers together produces a homogeneous matrix, and the dosing levels generally do not affect the matrix homogeneity. By contrast, in accordance with the invention, extruding immiscible polymers together beneficially produces a heterogeneous matrix that includes a plurality of separate domains or phases. Keeping the dosing level of the inventive admix to a minimum beneficially maintains the intended contributions of the host polymer to the extrudate properties.

As described herein, increasing the fluidity of, and thereby decreasing the peak shear stress acting upon the outer surfaces of, a fluid flow stream by use of an appropriately selected inventive admix has been experimentally found to favorably increase the production output capacity of a commercial scale extrusion line without slip-stick affects.

In accordance with the invention, the reduction in shear stress otherwise affecting the host polymer may further protect against deleterious decomposition of the host matrix. For example, consistent with benefits of the inventive process, addition of the inventive admix to a host polymer, such as a polyethylene, beneficially retards degradation of the molten host polymer by reducing its shear stress at the flow channel boundaries. Furthermore, the inventive technology is cost competitive or cost neutral to legacy and current polymer processing aides.

To achieve at least the foregoing, I have discovered thermoplastic polymers that can be advantageously admixed in minimal amounts, for example, in the range of about 1 to 3% wt., as an immiscible admix to thermoplastic polymers subject to slip-stick affects in order to effect a beneficial reduction in shear stress acting on the flow stream, below critical shear stress thresholds. These admix polymers are obtained by the polymerization of monoolefins having the general structure CH₂═CHR, where R is an alkyl radical beneficially containing not more than one carbon atom. In general, these useful polymers may be further characterized as non-polar, metallocene-catalyzed, polyolefin homopolymers immiscible with a host polymer, beneficially having a melting point higher than the host polymer, and a zero-shear viscosity less than or equal to 25 Pa·s, and beneficially below 10 Pa·s, at 230 °C (the “inventive admix”). An inventive admix may consist of a combination of these useful polymers.

The inventive admix may be further characterized as having a density selected from between about 0.85 and 0.91 g/cc, preferably 0.89 to 0.905 g/cc, in accordance with ASTM D792. Several homopolymer polypropylenes, beneficially free of peroxides or peroxide residuals, meeting the foregoing inventive admix specification are globally produced and commercially available, including, by way of example, Metocene MF650Y, Metocene MF650X, and Achieve pp 6936G2.

As previously described, it is desirable to dose with the least amount of admix sufficient to obtain an extruded article free of melt disturbances, including slip-stick defects. Accordingly, the higher the viscosity ratio between the host polymer and the inventive admix, the lower the admix content required to effect a beneficial reduction in shear stress; whereas, the lower the viscosity ratio between the host polymer and the inventive admix, the greater the admix content required to effect a beneficial reduction in shear stress. Thus, it can be understood that depending upon factors including the viscosity ratio, a sufficient level of an inventive admix may range from about 0.3 to 10% wt. of a host matrix. Within this range, and depending on the viscosity ratio, experimental data indicates that about 2-3% wt. may be beneficial. Factors affecting the amount of an inventive admix further include the severity of the slip-stick defects encountered or expected. As can thus be understood, using the guidelines herein described, including the Examples, the amount of an inventive admix required may be further optimized experimentally.

As described herein, an inventive admix migrates toward the high shear stress regions of a laminar flow field, i.e., the flow channel walls, under the principles of fluid dynamics. For a given shear rate, the time it takes for such migration to occur is dependent upon the viscosity relationship between the inventive admix and the host polymer. Generally speaking, the higher the viscosity ratio of the host polymer to the inventive admix, the faster the migration takes place; and conversely, the lower the viscosity ratio between the two immiscible polymers, the longer the migration takes. Additionally, the greater the shear rate, the less the time required to effect a given migration, and the lower the shear rate, the greater the time required to effect a given migration. The migration of the lower viscosity immiscible polymer is beneficially not fully effected by the time the flow stream exits the flow channel, at which point shear flow ends and migration of the immiscible polymer ceases. In any event, in accordance with the invention, an inventive admix abates unwanted slip-stick affects.

The viscosity ratio between the higher viscosity host polymer and the lower viscosity admix, and the time under shear flow and the magnitude of applied shear, influence the extent of migration that takes place. Under the same fluid dynamic principles, viscous migration, also commonly known as viscous rearrangement, viscous migration, time-migration deformation, and the like, between layers is well known and established in the field of coextrusion (e.g., see Dooley, Chapter 3).

Unlike traditional viscosity shifting effected by the blending of miscible polymers, the immiscibility of the inventive host admix effects a modification of the surface viscosity, compared to the entirety of the host matrix. That is, a plurality of immiscible domains of the inventive admix migrate to a high shear boundary of the host matrix. Thereupon, the plurality of low viscosity admix domains in contact with a flow channel boundary beneficially contribute to a reduction of flow resistance corresponding to their occupation of the surface area of the high shear boundary at a flow channel boundary. The reduction in flow resistance provides a corresponding reduction of the shear stress acting upon the flow stream.

With reference to a specific application of the present invention, polyethylenes, in particular polyethylene copolymers, commonly susceptible to slip-stick affects, generally have a zero-shear viscosity of at least 1,000 pascal seconds (“Pa·s”) at 230 °C. More commonly, some of these polyethylenes may be identified as LPEs having an MFI of approximately ≤3, and more commonly ≤2.

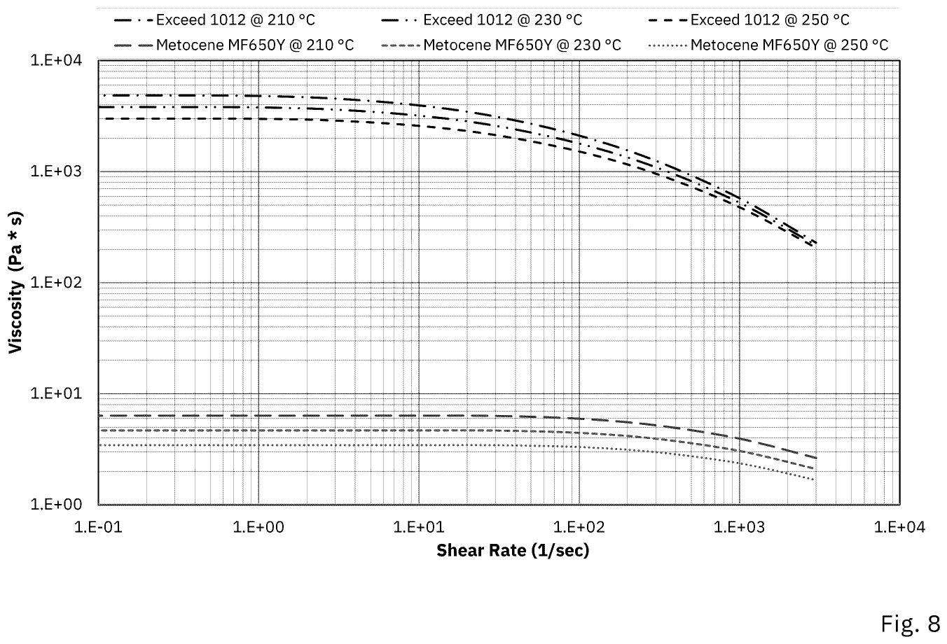

As indicated, for an inventive admix, a zero-shear viscosity of ≤25 Pa·s is beneficial, and a zero-shear viscosity of less than 10 Pa·s is even more beneficial, at 230 °C, and these are considered to be high fluidity thermoplastic polymers. Fluidity is the inverse of viscosity, i.e., when a fluid's viscosity decreases its fluidity increases, and vice-versa. In accordance with the present invention, the viscosity ratio, based on the zero-shear viscosity, of a host polymer subject to slip-stick affects to an inventive admix is at least 40:1, and beneficially at least 100:1, and, as further described, preferably at least 500:1. With reference to FIG. 8, a zero-shear viscosity ratio of ≥880:1 is illustrated between Exceed 1012MA and inventive admix Metocene MF650Y at 230 °C. As previously described, the greater the viscosity ratio between the host polymer and the inventive admix, the less inventive admix required.

Historically, high fluidity polypropylenes have been produced by a process commonly known as “visc-breaking”, commonly via peroxide reagents. However, peroxides are known to cause or accelerate degradation of molten polyethylenes. Accordingly, polymers containing peroxides or peroxide residuals should be avoided as an admix or reagent, in the extrusion of polyethylenes. Beneficially, an inventive admix is free of peroxides or peroxide residuals.

Advantageously, as illustrated by U.S. Pat. No. 10,883,197 to Lief et al., metallocene catalysts, including high activity catalysts, allow for certain rheological characteristics of polymers to be produced without the use of undesirable reagents, for example peroxides, which would otherwise be required to obtain desired rheological and/or morphological characteristics. I have found through multiple experiments, including extrusion trials, that use of high fluidity metallocene-catalyzed polymers as an inventive admix beneficially results in polyethylene-based extrudates otherwise subject to slip-stick affects, free of observable melt disturbances, and with no adverse effects on the polyethylene's thermal stability (and if anything, the opposite has been observed with regards to thermal stability). Homopolymer polypropylenes are beneficially known for, among other things, their relative thermal stability as a thermoplastic over a relatively broad extrusion temperature range.

Advantageously, use of an inventive admix at the described dosing will not upset the post-consumer polyethylene recycle stream. Like PFAS, the inventive admix is beneficially immiscible with polyethylenes.

Polyethylene and an inventive admix exhibit different time-temperature dependent degradation. In this respect, a further benefit of the use of the inventive admix as a processing aid in the inventive process, is that the admix exhibits inherently better time-temperature dependent stability compared to polyethylene. Polyethylenes cross-link as a result of degradation, thus increasing molecular weight, and ultimately forming observable black carbon deposits on the apparatus flow channel surfaces. The inventive admix, on the other hand, depolymerizes with time and temperature, thereby reducing its molecular weight. The beginning of this depolymerization is evidenced by an oily residual, much like the consistency of a cooking, or olive, oil. The oil-like volume is generally miniscule relative to the mass of the extrudate being processed and is not considered inconvenient or harmful.

Furthermore, unlike polyethylene degradation, no deleterious black particulates are observed if degradation of the inventive admix does occur, and not insignificantly, qualitative data shows that unwanted die lip build-up, by the deposit of degraded polyethylene on the flow surfaces, is reduced, or eliminated, by the inventive process. Beneficially, the extrusion run times between lip cleanings may be increased through the use of these types of polymer processing aids.

As previously described, it is desirable to use the least amount of an inventive admix sufficient to obtain the desired result of slip-stick abatement by reducing the shear stress acting upon a viscous flow stream below its critical shear stress, and with the least effect on the extrusion process or upon the extrudate properties.

PFAS and an inventive admix have contrasting mechanisms individually beneficial to abating slip-stick affects in the extrusion process, which are further described herein. As previously indicated, PFAS processing aids exhibit an affinity to metal due to the polar-to-polar attraction therebetween, and an inventive admix has no affinity to metal due to being non-polar. During extrusion, the immiscible PFAS migrates and separates from the viscous matrix, and adheres to the metal flow channel surfaces and thereby forming a boundary layer. Whereas, as immiscible domains within the viscous host polymer matrix, the lower viscosity inventive admix migrates to the high stress regions of a fluid flow stream in response to shear, thereby reducing the shear stress acting upon the flow stream, and ultimately the flow resistance of the flow stream (through energy dissipation principles).

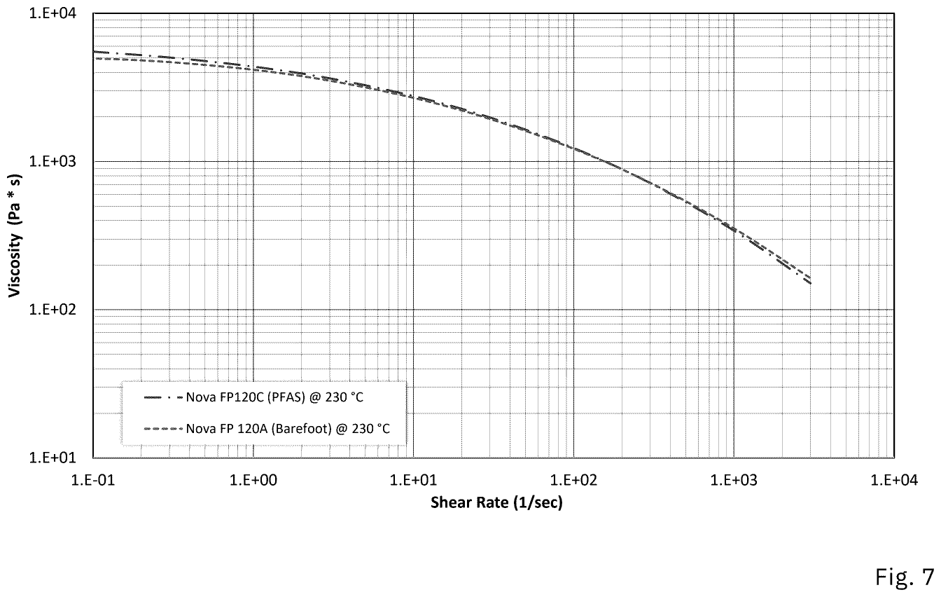

FIG. 7 compares the viscosity of Nova Chemical's PFAS-containing FP120C and PPA-free FP120A linear polyethylenes. As illustrated by the two viscosity curves, the use of small amounts of PFAS as a PPA in a polymer produces no significant difference in the polymer's viscosity. FP120 illustrates a zero-shear viscosity of ≥5,000 Pa·s at 230 °C. Furthermore, in my experience, the slight viscosity difference between the two samples is well within observed batch-to-batch production variations of thermoplastic polymers, including LPE's.

FIG. 8 illustrates shear rate vs. viscosity curves for a host polymer subject to slip-stick affects, Exceed 1012, and shear rate vs. viscosity curves for an inventive admix polymer, Metocene MF650Y, at three temperatures (210 °C, 230 °C, and 250 °C). As illustrated, the zero-shear viscosity ratio between the illustrative host polymer and the illustrative admix is approximately 880:1, at 230 °C.

As previously noted, it is normal and customary, that there may be viscosity variations from one batch of polymer to another batch of the same polymer, and yet remain within the manufacturer's or seller's specification. Accordingly, the viscosity data illustrated in FIGS. 7 and 8 should be understood to be representative and not absolute.

Beneficially, due to the relatively small dosing level of the inventive admix, effects on extruded article properties, as illustrated by reference to Table 3, are considered to be insignificant. Furthermore, as illustrated by reference to Table 1, an advantageous effect on extrusion output has been found.

Based on its relative fluidity, and its immiscibility with polyethylenes, an inventive admix beneficially reduces the flow resistance of the fluid matrix at the flow channel boundary, as evidenced by Examples 1-4.

In a specific application, depending on the viscosity characteristics of a host polymer, the amount of a selected grade of an inventive admix could be decreased, or may have to be increased, to achieve a shear stress reduction beneficial to abating slip stick affects. For example, for a higher zero-shear viscosity polyethylene, a higher dosing level of a selected inventive admix may be required; and for a lower zero-shear viscosity polyethylene, a lower dosing level of the selected admix may be sufficient.

Alternatively, a different MFR inventive admix could be used to achieve a desired shear stress reduction. For example, for a 0.5 MFI mLLDPE host polymer, an 1800 MFR inventive admix may be better suited as the admix; whereas, for a 1.5 MFI mLLDPE host polymer, a 1200 MFR polypropylene may be suitable as the admix, at like dosing levels. Or, for example, the required dosing level of an 1800 MFR admix may be less for a 1.5 MFI host polymer as compared to the dosing level required for a 0.5 MFI host polymer. Accordingly, there are at least two levers, a viscosity lever or a dosing lever, or a combination thereof, which may be selected to achieve the desired inventive result, i.e., abatement of unwanted slip-stick defects with minimal effects on the other properties of extruded articles.

As illustrated by Examples 1-4, PPAs in accordance with the present invention, have been evaluated with high viscosity Zeigler-Natta and metallocene catalyzed LPEs. Additionally, they have also been evaluated with both PFAS and PFAS-free LPEs, with no discernable difference in results observed.

### Example 1

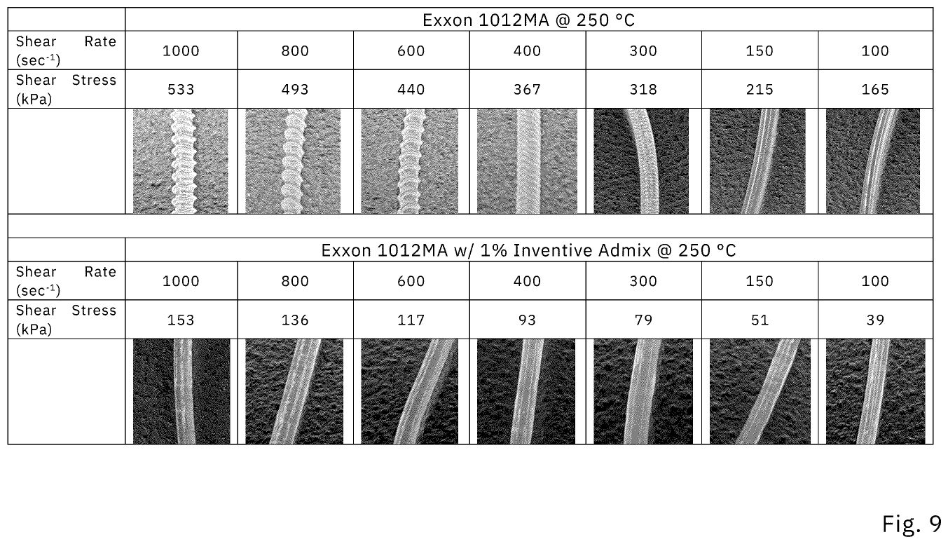

Initial experimentation was done with a Capillary Rheometer. A PFAS-containing ethylene 1-hexene mLPE copolymer (Exceed 1012-MA), was selected as the host polymer for this experiment. Several extruded samples were collected across a shear rate range of 100 to 1000 sec.⁻¹ at 250 °C. As can be observed in FIG. 9, slip-stick affects are present at shear rates of 300 sec.⁻¹ and higher.

As further illustrated by FIG. 9, capillary rheometry demonstrates that dosing a host polymer subject to slip-stick affects, Exceed 1012, with 1% wt. of an inventive admix, Metocene MF650Y, decreased the flow resistance of the host matrix below the critical shear stress threshold of the host polymer. By comparison, the PFAS-containing host polymer, without the inventive admix, clearly begins to demonstrate a slip-stick effect at a shear rate of about 300 sec.⁻¹, and above. Like results have been obtained with Exxon Exceed 1012-RA, a PFAS-free polymer.

Specifically, and with continued reference to the photographs of FIG. 9, at a shear rate of 300 sec.⁻¹, the peak shear stress for the inventive admix-free host polymer is 318 kPa at 250 °C, at which slip-stick disturbances on the extruded sample are observed. By comparison, the peak shear stress acting on the inventive extruded polymeric composition comprising the same host polymer dosed with 1% wt. of the inventive admix at a shear rate of 1,000 sec.⁻¹ is 153 kPa at 250 °C, with no slip-stick defects observed. It is known that every polymer, and polymeric matrix, exhibits its own unique critical stress signature owing to its physical and chemical make-up, including its molecular structure, molecular weight, and weight distribution. As such, the critical stress limit for any individual polymer or polymeric matrix susceptible to slip-stick flow behavior can only be identified empirically through design of experiments (“DOE”).

In commercial scale experimentation, it has been found that a dosage level of the same inventive admix between about 1-3% wt. is more effective with low MFI LPEs, and a dosage level of about 2-3% wt. was found to be beneficial.

### Example 2

With reference to another experiment, a multilayer coextruded cast film including Nova Chemical FP120, a 1-octene copolymer LLDPE (layer A) as one outer surface layer and Exxon Exceed 1012RA metallocene-catalyzed, 1-hexene copolymer LLDPE (layer K) as the opposing outer surface layer, was produced. Each skin layer accounted for approximately 10% of the total mass extrusion output. A Control Sample was extruded without an inventive admix. The Control Sample total output rate was limited to about 465 kg/hr due to slip-stick disturbances above about 465 kg/hr. For comparison, 2.5% wt. of the same inventive admix used in Example 1, was added to layer A only, and an output rate of about 800 kg/hr was achieved free of observable slip-stick defects. The addition of the inventive admix to only one outer layer decreased the peak shear stress acting on the entire melt stream. Higher output rates were not attempted due to other process limitations restricting further increase of the output rate.

### Example 3

An extrusion line that is generally described in Table 1, was used to make two blown film samples from the resin compositions described in the Table. Tables 1-3 compare two LPE blown film samples, the Control Sample T3 and the Experimental Sample ET3. The only difference between the two sample recipes is that Control Sample T3 is free of an inventive admix, while Experimental Sample ET3 incorporates 3% wt. of the inventive admix described in Table 2 in only the skin layers (extruders A, C) of the three-layer film. As may be further understood by reference to FIG. 3, skin layers A, C include the opposing outer surfaces of the coextruded film structure.

Control Sample T3 exhibited slip-stick defects under the extrusion conditions illustrated in Table 1. The slip-stick defects were abated in Experimental Sample ET3 by the introduction of the inventive admix as illustrated in Tables 1-2.

With continued reference to the Experimental Sample ET3, the host matrix of layers A, C included 97% wt. of a metallocene-catalyzed, LPE described in Tables 1 and 2. A resin composition consisting of 65% wt. of a metallocene-catalyzed LPE, and 35% wt. of a second LPE, both referenced in Table 1 and described in Table 2, was fed into the B extruder of the blown film extrusion line to form the B-layer matrix. A blown film having the A/B/C layer sequence was extruded, with no observable melt disturbances.

With particular reference to Table 1, the head pressures of the A and C extruders are observed to be relatively constant despite the ≥30% increase production throughput for Experimental Sample ET3. This is contrary to what would be expected without the inventive admix. By comparison, a 41 Bar pressure increase is recorded for extruder B (the only extruder without the addition of an inventive admix) and is associated with the 34% increase in output. By comparison, a 41 Bar pressure increase on extruders A, C would be the minimum anticipated pressure increase without the addition of the inventive admix. The differences in head pressures found between

TABLE 1

| Equipment | Blown Film Extrusion Line | | |
|---|---|---|---|
| Layer Designation | A | B | C |
| Mass Contribution (%) | 12 | 76 | 12 |
| Die Diameter (mm) | 400 | | |
| Lip Gap (mm) | 1.25 | | |
| Die Temperature (°C) | 200 | | |
| BUR | 2.9:1 | | |
| (Blow-up Ratio) | | | |
| Film Thickness (μm) | 62 | | |
| Polymer Matrix | Lumicene 22ST05 | 65% Marlex D350 | Lumicene 22ST05 |
| (Control Sample T3) | | and | |
| | | 35% Marlex HHM | |
| | | TR-131 | |
| Polymer Matrix | 97% Lumicene | 65% Marlex D350 | 97% Lumicene |
| (Experimental Sample | 22ST05 | and | 22ST05 |
| ET3) | and | 35% Marlex HHM | and |
| | 3% inventive admix | TR-131 | 3% inventive admix |
| Extruder Head Pressure | 453 | 500 | 392 |
| (Bar) | | | |
| (Control Sample T3) | | | |
| Extruder Head Pressure | 461 | 541 | 396 |
| (Bar) | | | |
| (Experimental Sample ET3) | | | |
| Mass Output¹ (kg/hr) | 412 | | |
| (Control Sample T3) | | | |
| Mass Output² (kg/hr) | 553 | | |
| (Experimental Sample ET3) | | | |

¹Mass output limited by Melt Fracture onset.
²Mass output limited by extrusion capacity.

TABLE 2

| | | MFI/MFR | Density |
|---|---|---|---|
| Tradename | Classification | ASTM D1238 | ASTM D792 |
| Lumicene 22ST05 | mLPE | 0.5¹ | 0.921 |
| Marlex D350 | mLPE | 0.9¹ | 0.933 |
| Marlex HHM TR-131 | LPE | 0.2¹ | 0.938 |
| Metocene MF650X | Polypropylene | 1200² | 0.90 |
| (inventive admix) | | | |

¹MFI @ 190 °C
²MFR @ 230 °C

TABLE 3

| | Flex | Elongation at | Force at | Elmendorf | | | |
|---|---|---|---|---|---|---|---|
| | Modulus | Break | Break | Tear | Haze | | COF |
| | (MPa) | (%) | (N) | (g/μm) | (%) | Gloss | (μS) |
| Test Method | DIN EN ISO | DIN EN ISO | DIN EN | DIN EN ISO | ASTM | ASTM | DIN EN |
| | 527-1 | 527-1 | ISO 527-1 | 6383-2 | D1003 | D1003 | ISO 8295 |
| Control Sample | (MD) 389 | (MD) 571 | (MD) 46.4 | (MD) 4.5 | 11 | Side 1 | Static 0.44 |
| T3 | (TD) 457 | (TD) 619 | (TD) 46.4 | (TD) 15.7 | | (MD) 52.2 | Dynamic |
| | | | | | | (TD) 56.1 | 0.35 |
| | | | | | | Side 2 | |
| | | | | | | (MD) 54.3 | |
| | | | | | | (TD) 57.4 | |
| Experimental | (MD) 444 | (MD) 559 | (MD) 47.6 | (MD) 3.5 | 10.1 | Side 1 | Static 0.41 |
| Sample ET3 | (TD) 486 | (TD) 626 | (TD) 47.1 | (TD) 15.2 | | (MD) 64.8 | Dynamic |
| | | | | | | (TD) 63.2 | 0.33 |
| | | | | | | Side 2 | |
| | | | | | | (MD) 67.1 | |
| | | | | | | TD 65.6 | |

extruders A, C is attributable to differences in flow channel design for each respective flow path.

As noted in the notes under Table 1, no observable slip-stick disturbances were found in Experimental Sample ET3, even at the increased output of 34%. And not insignificantly, the output rate of the extrusion line was allowed to increase without slip-stick affects, thus offering significant economic benefit from the inventive extrusion process.

Reference is made to the Control and Experimental Sample data in Table 3 for properties of the extruded blown film. The differences in properties were considered to be largely attributable to the difference in the output rates between Control Sample T3 and Experimental Sample ET3, and these properties were determined to be within acceptable variation limits.

As previously described and referring again to Table 1, by using an inventive admix in a LPE host polymer in only the outer layers of the coextruded blown film, an output rate increase of more than 30% has been achieved by the inventive extrusion process with no observable melt disturbances. More specifically, increasing the fluidity of only the outside A, C layers, by use of an appropriately selected inventive admix has been found to favorably affect the production capacity of the extrusion line by a 34% increase in throughput, free of slip-stick affects. The increase in production capacity was limited only by the output capacity of the machine. Accordingly, the beneficial effect of an inventive admix on energy dissipation at the A and C flow channel walls is experimentally validated by Example 3.

### Example 4

In another experiment and with reference to Tables 4-6, a DOE on a cast film was conducted, comprising both a Control Sample T4 and an Experimental Sample ET4, consistent with Tables 4-6. The only difference between the two sample recipes is that Control Sample T4 is free of an inventive admix, while Experimental Sample ET4 incorporates 2.5% wt. of an inventive admix described in Table 5, in only the skin layers (extruders A, G) of the multi-layer cast film. As may be further understood by reference to FIG. 4, skin layers A, G include the opposing outer faces of the coextruded film structure.

Control Sample T4 exhibited slip-stick defects under the extrusion conditions illustrated in Table 4. The slip-stick defects were abated in Experimental Sample ET4 by the introduction of the inventive admix as shown in Table 4-5.

With continued reference to experimental sample ET4, the remainder of the host matrix of outer layers A, G included 96% wt. of a metallocene-catalyzed LPE and 1.5% wt. of an antiblock additive, both described in Tables 4 and 5. The resin compositions of the multilayer structure separating layers A, G consist of mLPE's in the weight percentages shown, and are all referenced in Table 4 and described in Table 5. These resin compositions were fed into the extruders specified in Table 4 to form the multilayer structure separating layers A, G. A multilayer cast film was produced, with no observable melt disturbances.

With particular reference to Table 4, for extruders A, G a significant reduction in head pressure is observed for Experimental Sample ET4 compared to Control Sample T4. This ≥50 Bar reduction of head pressure is a significant contribution to the extrusion process and to energy savings. The moderate reduction in head pressure exhibited for Experimental Sample ET4 on extruders B-F is related to the benefit of the lower pressures exhibited by skin layer extruders A, G. As described earlier, the reduction in head pressure correlates to a reduction of peak shear stress at a boundary wall. Accordingly, the reduction of shear stress by the inventive admix at the A and G flow channel walls is experimentally validated by Example 4.

Reference is made to the Control and Experimental Sample data in Table 6 for properties of the extruded blown film. The differences in film properties were determined to be within acceptable variation limits.

Various embodiments and modifications have been described. The present invention may be carried out with other modifications without departing from the spirit or essential attributes thereof. Accordingly, reference should be made to the appended claims as indicating the scope of the invention.

TABLE 4

| Equipment | Cast Film Extrusion Line | | | | | | | | |
|---|---|---|---|---|---|---|---|---|---|
| Layer | A | B | C | D | C | D | E | F | G |
| Designation | | | | | | | | | |
| Mass | 10 | 40 | 7.5 | 5 | 7.5 | 5 | 10 | 5 | 10 |
| Contribution | | | | | | | | | |
| (%) | | | | | | | | | |
| Film | 157 | | | | | | | | |
| Thickness | | | | | | | | | |
| (μm) | | | | | | | | | |
| Die Width | 2400 | | | | | | | | |
| (mm) | | | | | | | | | |
| Die Gap | 0.9 | | | | | | | | |
| (mm) | | | | | | | | | |
| Die | 240 | | | | | | | | |
| Temperature | | | | | | | | | |
| (°C) | | | | | | | | | |
| Polymer Matrix | 98.5% | 75% | 85% | 85% | 85% | 70% | 70% | 80% | 98.5% |
| (Control | AT6900 | 5940ST | AT6900 | AT6900 | AT6900 | 5400GS | 5400GS | AT6900 | AT6900 |
| Sample T4) | and | and | and | and | and | and | and | and | and |
| | 1.5% | 25% | 15% | 15% | 15% | 30% | 30% | 20% | 1.5% |
| | AB | AT6900 | 5940ST | 5940ST | 5940ST | 5940ST | 5940ST | 5940ST | AB |
| Polymer Matrix | 96% | 75% | 85% | 85% | 85% | 70% | 70% | 80% | 96% |
| (Experimental | AT6900 | 5940ST | AT6900 | AT6900 | AT6900 | 5400GS | 5400GS | AT6900 | AT6900 |
| Sample ET4) | and | and | and | and | and | and | and | and | and |
| | 2.5% | 25% | 15% | 15% | 15% | 30% | 30% | 20% | 2.5% |
| | Inventive | AT6900 | 5940ST | 5940ST | 5940ST | 5940ST | 5940ST | 5940ST | Inventive |
| | Admix | | | | | | | | Admix |
| | and | | | | | | | | and |
| | 1.5% | | | | | | | | 1.5% |
| | AB | | | | | | | | AB |
| Extruder Head | 335 | 334 | 339 | 342 | 339 | 309 | 374 | 29 | 343 |
| Pressure (Bar) | | | | | | | | | |
| (Control | | | | | | | | | |
| Sample T4) | | | | | | | | | |
| Extruder Head | 279 | 322 | 325 | 328 | 325 | 297 | 359 | 276 | 291 |
| Pressure (Bar) | | | | | | | | | |
| (Experimental | | | | | | | | | |
| Sample ET4) | | | | | | | | | |

| | |
|---|---|
| Nominal Mass | 600 |
| Output (kg/hr) | |
| (Control | |
| Sample E4) | |
| Nominal Mass | 600 |
| Output (kg/hr) | |
| (Experimental | |
| Sample ET4) | |

TABLE 5

| | | MFI/MFR | Density |
|---|---|---|---|
| Tradename | Classification | (ASTM D1238) | (ASTM D792) |
| Elite 5940ST | mLPE | 0.8¹ | 0.941 |
| Elite AT6900 | mLPE | 1.2¹ | 0.969 |
| Elite 5400GS | mLPE | 1¹ | 0.916 |
| Metocene MF650Y | Polypropylene | 1800² | 0.90 |
| (Inventive admix) | | | |
| AB | Antiblock | — | 0.952 |

¹MFI @ 190 °C
²MFR @ 230 °C

TABLE 6

| | | | | | | | | | | Gloss | | |
|---|---|---|---|---|---|---|---|---|---|---|---|---|
| | Flex | | Elongation | | Force at | | Elmendorf | | | (Chill | | |
| | Modulus | | at Break | | Break | | Tear | | Haze | Roll | | COF |
| | (MPa) | | (%) | | (N) | | (g/μm) | | (%) | Side) | | (μs) |
| Test | DIN EN | | DIN EN | | DIN EN | | DIN EN | | ASTM | ASTM | | DIN EN |
| Method | ISO | | ISO | | ISO | | ISO | | D1003 | D1003 | | ISO |
| | 527-1 | | 527-1 | | 527-1 | | 6383-2 | | | | | 8295 |
| Control | (MD) | 674 | (MD) | 708 | (MD) | 111 | (MD) | 351 | 53 | (MD) | 45 | Static |
| Sample | (TD) | 737 | (TD) | 725 | (TD) | 96 | (TD) | 655 | | (TD) | 41 | 0.2 |
| (T4) | | | | | | | | | | | | Dynamic |
| | | | | | | | | | | | | 0.17 |
| Experimental | (MD) | 692 | (MD) | 699 | (MD) | 104 | (MD) | 331 | 57 | (MD) | 44 | Static |
| Sample | (TD) | 799 | (TD) | 700 | (TD) | 86 | (TD) | 616 | | (TD) | 41 | 0.2 |

| | |
|---|---|
| (ET 4) | Dynamic |
| | 0.16 |

1. An extruded plastic article free of slip-stick defects, and comprising a host matrix, wherein said host matrix comprises at least the host polymer thereof admixed with, as a minor constituent, an immiscible second polymer thereof, wherein said host polymer is a higher viscosity polymer than said immiscible second polymer, and is a host polymer subject to slip-stick affects, wherein said second polymer is a metallocene-catalyzed homopolymer obtained by polymerization of olefins having the general structure CH₂═CHR, where R is an alkyl radical comprising not more than one carbon atom, and wherein said second polymer has a zero-shear viscosity less than, or equal to, 25 Pa·s at 230 °C.

2. The plastic article of claim 1, wherein said plastic article comprises at least one layer.

3. The plastic article of claim 1, comprising multiple layers wherein the composition of at least one of the multiple layers is different from the composition of another of the multiple layers.

4. The plastic article of claim 3, wherein said article is a multi-layered article comprising outer layers providing opposing outer faces, and one of the outer layers comprises said host matrix, and the other outer layer comprises a second host matrix, and wherein the host polymers of said host matrix and said second host matrix are the same or different from one another.

5. The plastic article of claim 4, wherein the second polymers of said host matrix and said second host matrix are the same or different from one another.

6. The plastic article of claim 1, wherein said host polymer comprises a polyethylene.

7. The plastic article of claim 1, wherein said second polymer is free of peroxide or peroxide residuals.

8. The plastic article of claim 1, wherein said host matrix comprises from about 0.3 to 10% wt. of said second polymer.

9. The plastic article of claim 1, wherein said host matrix comprises from about 0.3 to 5% wt. of said second polymer.

10. The plastic article of claim 1, wherein said host matrix comprises from about 0.3 to 3% wt. of said second polymer.

11. The plastic article of claim 1, wherein said host matrix is comprised of at least 50% wt. of thermoplastic polymers.

12. The plastic article of claim 1, wherein the viscosity ratio, based on zero-shear viscosity, of said host polymer to said second polymer is at least 40:1.

13. The plastic article of claim 12, wherein said viscosity ratio is at least 100:1.

14. The plastic article of claim 12, wherein said viscosity ratio is at least 500:1.

15. The plastic article of claim 1, wherein said host polymer has a zero-shear viscosity of at least 1,000 Pa·s at 230 °C.

16. The plastic article of claim 1, wherein said host polymer has a melt flow index equal to, or less than, 3.

17. The plastic article of claim 1, comprising opposing faces that are generally coplanar.

18. The plastic article of claim 1, comprising opposing faces that are generally concentric.

19. The plastic article of claim 1, wherein said host polymer and said second polymer are co-recyclable.

20. The plastic article of claim 1, wherein said plastic article is a PFAS-free article selected from a film, annular article, and parison.

21. The plastic article of claim 1, wherein said plastic article is a thermoplastic article.

22. The plastic article of claim 1, wherein a plurality of domains of said second polymer occupy an exterior surface of said host matrix.

23. The plastic article of claim 1, wherein said plastic article is produced by an extrusion process comprising,
extruding a viscous polymeric flow stream through a flow channel that includes an extrusion die, wherein the viscous flow stream comprises said host matrix wherein said second polymer is selected to abate slip-stick affects otherwise affecting said host polymer, and wherein the lower viscosity and immiscibility of said second polymer relative to said host polymer allows for viscous migration of a plurality of domains of said second polymer to a surface of said host matrix in direct fluid communication with a boundary of said flow channel, whereby the shear stress acting on said viscous flow stream is reduced below a critical shear stress of said host polymer, and whereby slip-stick affects are abated, and
thereafter converting said viscous flow stream into a plastic article free of slip-stick defects.

24. An extruded polymeric composition comprising a host matrix, wherein said host matrix comprises at least the host polymer thereof admixed with, as a minor constituent, an immiscible second polymer thereof, wherein during extrusion, said host polymer is subject to slip-stick affects, wherein said second polymer is a metallocene-catalyzed homopolymer obtained by polymerization of olefins having the general structure CH₂═CHR, where R is an alkyl radical comprising not more than one carbon atom, wherein said second polymer has a zero-shear viscosity less than, or equal to, 25 Pa·s at 230 °C, and wherein the viscosity ratio, based on zero-shear viscosity, of said host polymer to said second polymer is at least 40:1, said polymeric composition being PFAS-free and useful for converting into a PFAS-free plastic article free of slip-stick defects.

25. The extruded polymeric composition of claim 24, wherein said host polymer comprises a polyethylene.

26. The extruded polymeric composition of claim 24, wherein said host matrix comprises from about 0.3 to 5% wt. of said second polymer.

27. The extruded polymeric composition of claim 24, wherein said host matrix comprises from about 0.3 to 3% wt. of said second polymer.

28. The extruded polymeric composition of claim 24, wherein said host matrix is comprised of at least 50% wt. of thermoplastic polymers.

29. The extruded polymeric composition of claim 24, wherein said viscosity ratio is at least 100:1.

30. The extruded polymeric composition of claim 24, wherein said viscosity ratio is at least 500:1.

31. The extruded polymeric composition of claim 24, wherein said second polymer is free of peroxide or peroxide residuals.

32. The extruded polymeric composition of claim 24, being a plastic pellet.

33. An extrusion process for producing a polymeric article free of slip-stick defects, wherein said extrusion process comprises extruding a viscous flow stream through a flow channel that includes an extrusion die, wherein said viscous flow stream comprises a host matrix, wherein said host matrix comprises at least the host polymer thereof admixed with, as a minor constituent, an immiscible second polymer thereof, wherein said second polymer is a metallocene-catalyzed homopolymer obtained by polymerization of olefins having the general structure CH₂═CHR, where R is an alkyl radical comprising not more than one carbon atom, wherein said host polymer has a higher viscosity than said second polymer and is subject to unwanted slip-stick affects, and wherein the lower viscosity and immiscibility of said second polymer relative to said host polymer allows for viscous migration of a plurality of domains of said second polymer to a surface of said host matrix in direct fluid communication with a boundary of said flow channel,
whereby the shear stress acting on said viscous flow stream is reduced below a critical shear stress of said host polymer and whereby said slip-stick affects are abated, and
thereafter converting said viscous flow stream to a plastic article free of slip-stick defects.

34. The process of claim 33, wherein said viscous flow stream is a multilayer flow stream and comprises a second host matrix, and said plastic article is a multilayer plastic article comprising outer layers, wherein one outer layer thereof comprises said host matrix, and the other layer thereof comprises said second host matrix, and wherein the host polymers of said host matrix and of said second host matrix are the same or different from one another.

35. The process of claim 34, wherein the second polymers of said host matrix and of said second host matrix are the same or different from one another.

36. The process of claim 33, wherein said plastic article comprises one or more layers.

37. The process of claim 33, wherein said host polymer comprises a polyethylene.

38. The process of claim 33, wherein said second polymer is free of peroxide or peroxide residuals.

39. The process of claim 33, wherein said host matrix comprises from about 0.3 to 10 wt. % of said second polymer.

40. The process of claim 33, wherein said host matrix comprises from about 0.3 to 5 wt. % of said second polymer.

41. The process of claim 33, wherein said host matrix comprises from about 0.3 to 3 wt. % of said second polymer.

42. The process of claim 33, wherein said host polymer is a polymer having a melt flow index equal to, or less than, 3.

43. The process of claim 33, wherein said host polymer has a zero-shear viscosity of at least 1,000 Pa·s at 230 °C.

44. The process of claim 33, wherein said second polymer has a zero-shear viscosity less than, or equal to, 25 Pa·s at 230 °C.

45. The process of claim 44, wherein the viscosity ratio based on zero-shear viscosity, of said host polymer to said second polymer, is at least 40:1.

46. The process of claim 45, wherein said viscosity ratio is at least 100:1.

47. The process of claim 45, wherein said viscosity ratio is at least 500:1.

48. The process of claim 33, wherein said plastic article is PFAS-free.

49. The process of claim 33, wherein the plastic article is a thermoplastic article.

50. The process of claim 33, wherein said surface of said host matrix in said direct fluid communication, comprises said host polymer and said plurality of said domains of said second polymer.
